(19) United States
(12) Patent Application Publication
(10) Pub. No.: US 2002/0144251 A1
(43) Pub. Date: Oct. 3, 2002

(54) Method for upgrading software program

(76) Inventor: Sang Kyu Cho, Seongnam (KR)

Correspondence Address: BIRCH STEWART KOLASCH & BIRCH, PO BOX 747, FALLS CHURCH, VA, 22040-0747, US

(21) Appl. No.: 10/108,723

(22) Filed: Mar. 29, 2002

(30) Foreign Application Priority Data
Mar. 30, 2001 (KR) 16892/2001

(51) Int. Cl. G06F 9/44

(52) U.S. Cl. 717/168

(57) ABSTRACT

A method for upgrading a software program including the steps of receiving data of a soft program separated to a plurality of blocks and installing the software program in the receiver by collecting the above plurality of blocks can improve speed for upgrading a software program of a satellite broadcasting receiver, minimize data transmission time for upgrading and increase upgrade success degree.

### BACKGROUND OFF THE INVENTION

1. Field of the Invention

The present invention relates to a method for upgrading a software program and particularly, to a method for upgrading a software program in a satellite-broadcasting receiver by receiving data broadcasted from a satellite.

2. Description of the Background Art

Generally, a satellite broadcasting receiver (not shown) transmits a source code of a software program which will be upgraded to a satellite broadcasting is station (not shown). Later, the satellite receiver receives data of the upgraded software program and installs the received software program in the satellite broadcasting receiver after testing the received data. Such conventional art will be described with reference to FIG. 1.

FIG. 1 is a flow chart showing a method for upgrading a software program of a conventional satellite-broadcasting receiver.

As shown in FIG. 1, to upgrade the program in the satellite broadcasting receiver, the source code of the program which will be upgraded is transmitted to the satellite broadcasting station (S11). At this time, the satellite broadcasting station broadcasts the broadcasting schedule for upgrading in advance.

Later, the satellite broadcasting receiver receives the broadcasting schedule (S12), prepares for upgrading at the scheduled broadcasting time (S13) and receives data of the upgraded software program repeatedly (S14). At this time, the satellite broadcasting receiver tests validity of the data of the upgraded software program (S15) and installs the upgraded program in the satellite broadcasting receiver (S16).

FIG. 2 is an exemplary view showing a data stream of a conventionally upgraded software program.

As shown in FIG. 2, the upgraded data are transmitted repeatedly for a certain time preparing against a case that the software program in the satellite broadcasting receiver can not be upgraded by damage of a part of the data of the program by weather an the like in receiving the data of the upgraded software program. Namely, when the satellite broadcasting station transmits a data stream for upgrading the software program the satellite broadcasting station transmits the data stream of the program to the satellite broadcasting receiver several times for a certain time since the satellite broadcasting receiver receives the program data in one direction and it is not possible for the satellite broadcasting station to check whether the receiver received the data.

As described above, in case the part of the data is damaged by a wave jam in receiving the data of the software program through the satellite, the conventional satellite broadcasting receiver receives the data of the software program after waiting until transmission of the data, which will be repeated continuously is resumed. Therefore, in case the state of the satellite broadcasting is not even, time for upgrading the software program of the satellite broadcasting receiver is lengthened or upgrading of the software program is not possible.

### SUMMARY OF THE INVENTION

Therefore, the present invention provides a method for upgrading a software program which can improve speed for upgrading a software program of a satellite broadcasting receiver, minimize data transmission time needed for upgrading and increase upgrade success degree.

To achieve these and other advantages and in accordance with the purpose of the present invention, as embodied and broadly described herein, there is provided a method for upgrading a software program including the steps of receiving data of a soft program separated to a plurality of blocks and installing the software program in the receiver by collecting the above plurality of blocks.

The foregoing and other, features, aspects and advantages of the present invention will become more apparent from the following detailed description when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a flow chart showing a method for upgrading a software program of a conventional satellite-broadcasting receiver;

FIG. 2 is an exemplary view showing a data stream of a conventionally upgraded software program;

FIG. 3 is a flow chart showing a method for upgrading a software program of a satellite broadcasting receiver in accordance with the present invention; and

FIG. 4 is a flow chart of data signals of an upgraded software program in accordance with the present invention.

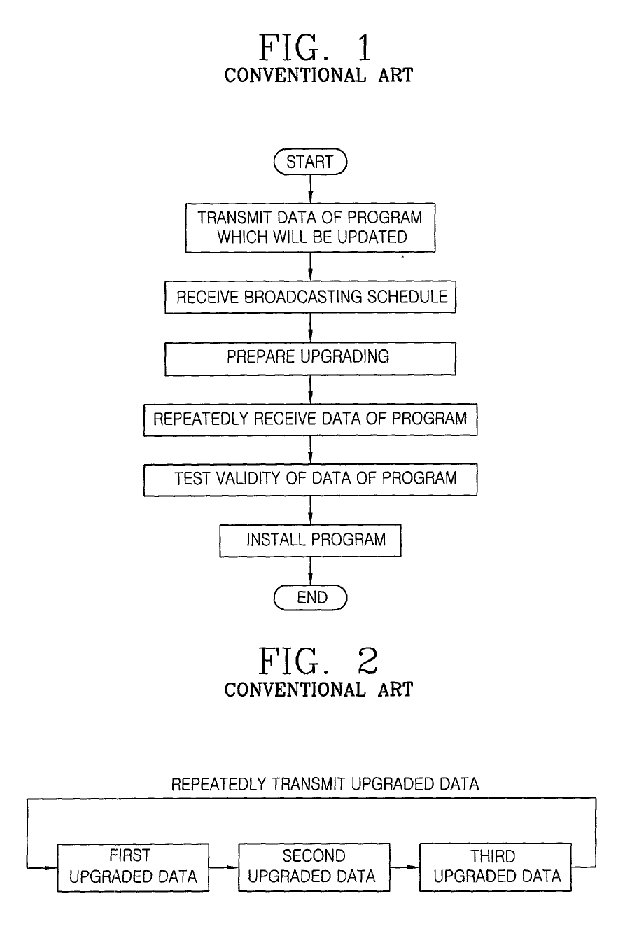

### DETAILED DESCRIPTION OF THE PREFERRED EMBODIMENTS

Reference will now be made in detail to the preferred embodiments of the present invention, examples of which are illustrated in the accompanying drawings.

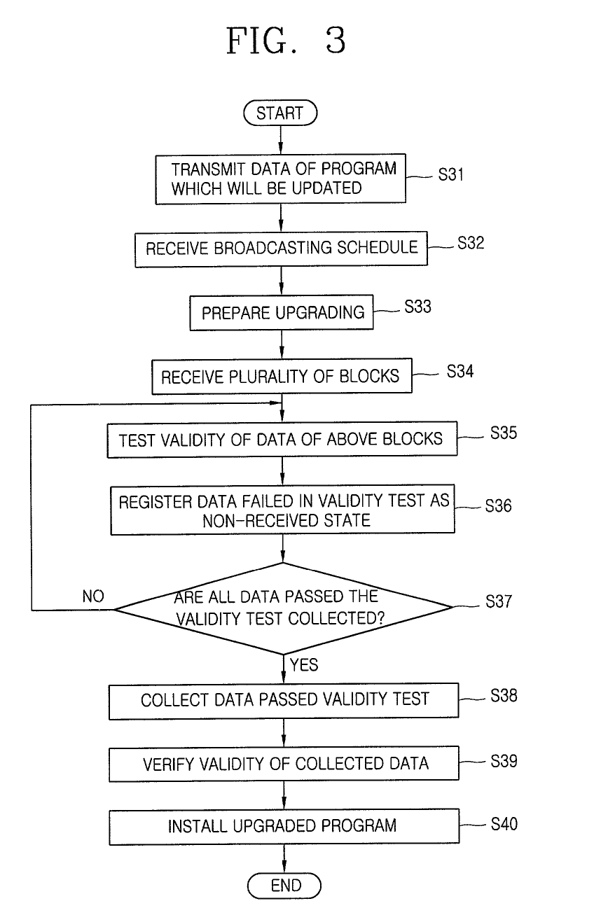

FIG. 3 is a flow chart showing a method for upgrading a software program of a satellite broadcasting receiver in accordance with the present invention.

As shown in FIG. 3, to upgrade a software program of a satellite broadcasting receiver (not shown), the source code of the software program is transmitted into a satellite broadcasting station (not shown) (S31) and the station broadcasts the broadcasting schedule for upgrading in advance.

Later, the satellite broadcasting receiver receives the broadcasting schedule (S32) and prepares for enabling upgrade at the scheduled broadcasting time (S33).

On the other hand, the satellite broadcasting station divides the data of the upgraded software program into a plurality of blocks and transmits the divided blocks into the, satellite broadcasting receiver through a plurality of broadcasting channel. At this time, the satellite broadcasting receiver receives the plurality of blocks (S34) and collects the blocks.

Later, the satellite broadcasting receiver tests validity of the data corresponding to the blocks (S35), abandons data failed in the validity test and registers it as a non-received state (S36). On the other hand, the satellite broadcasting receiver determines whether data which passed the validity test are all collected (S37).

In the determining process (S37), in case all data are not collected, the process (S35) of testing validity of the data corresponding to the blocks is repeatedly performed by receiving the plurality of blocks.

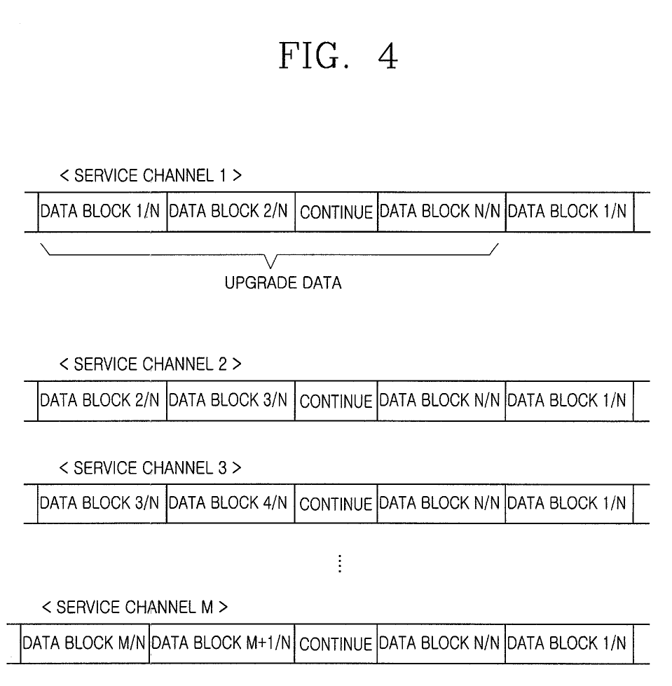

In the determining process (S37), in case all data are collected, validity of the collected data is verified (S38). Namely, the satellite broadcasting receiver verifies validity of data of the updated software program transmitted from the satellite station at the broadcasting time of the upgraded data and installs the program in the satellite broadcasting receiver (S39). Hereinafter, the process of receiving, verifying and installing the upgraded software program will be described with reference to FIG. 4.

FIG. 4 is a flow chart of data signals of an upgraded software program in accordance with the present invention.

As shown in FIG. 4, when the upgraded data is transmitted to the satellite broadcasting receiver, the satellite broadcasting station divides data of the upgraded software program into a plurality of blocks and transmits the blocks to the satellite broadcasting receiver through the plurality of channels (for example, 1˜M) simultaneously. Here, the satellite broadcasting station transmits the plurality of blocks having a time difference of the block unit time for each broadcasting channel.

Later, the satellite broadcasting receiver receives data blocks which are not collected among the data blocks transmitted to the respective channels simultaneously. Also, the satellite broadcasting receiver checks whether the data block is not collected and if the block is not received yet, the data block is received. After testing validity of the data existing in the data block, the result is stored in the internal memory (not shown). At this time, the satellite broadcasting receiver does not store the validity in the memory in case the data existing in the received data block is not valid by being damaged by external noise and registers the data block as a state of non-received.

Also, the satellite broadcasting receiver repeats the validity test of data of the data block until all of the data blocks are normally collected. Namely, the satellite broadcasting receiver performs the validity test by continuously receiving the data block until the updated software programs are all transmitted.

Later, the satellite broadcasting receiver performs the validity verification for all data of the received program strictly when the data blocks are all collected and all data of an upgraded software program are received and installs the upgraded software program. Namely, the satellite broadcasting program which collected all data of the valid software program completes upgrading of the software program by storing data of the valid software program in a nonvolatile memory (not shown) positioned in the receiver or a memory where a main program for operating the satellite broadcasting receiver is stored.

As described above, the present invention can restore, data damaged by external noise swiftly by dividing data of an upgraded software program into a plurality of blocks, receiving the divided blocks, storing and managing the blocks individually.

Also, the present invention has an advantage that data of the divided software program can be swiftly received in the satellite broadcasting receiver by transmitting the data of the divided software program divided into a plurality of blocks through a plurality of broadcasting channels.

Also, the present invention can be applied in the field of data broadcasting such as internet broadcasting and public wave broadcasting, thus to improve data reception rate and data speed caused by deterioration of the channel.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for upgrading a software program comprising the steps of;
receiving data of a soft program separated to a plurality of blocks; and
installing the software program in the receiver by collecting the above plurality of blocks.

2. The method of claim 1, wherein the plurality of blocks are transmitted from the satellite broadcasting station.

3. The method of claim 1, wherein the receiver is a satellite broadcasting receiver.

4. The method of claim 1, wherein the data of the software program is an upgraded program.

5. The method of claim 1, wherein the plurality of blocks are transmitted through a plurality of broadcasting channel.

6. The method of claim 1, wherein the broadcasting receiver tests validity of the data existing in the plurality of blocks.

7. The method of claim 6, wherein the data failed in the validity test is registered as a non-received state.

8. The method of claim 6, wherein the receiver verifies validity of the software program collected after being passed the validity test.

9. The method of claim 1, wherein the plurality of blocks are transmitted having a time difference of the block unit time for each broadcasting channel.

10. The method of claim 1, further comprising a step of:
testing validity of the data block by receiving data blocks which are not collected among the data blocks transmitted through each channel.

11. The method of claim 1, wherein the data blocks are stored in a memory of the receiver.

12. The method of claim 1, further comprising a step of:
registering the block as a non-received state in case data in the received plurality of blocks are damaged by external noise and not valid and repeating the validity test until the data blocks are all collected normally.

13. The method of claim 1, wherein the receiver stores verified blocks in an, inner memory where a main program is stored after it collects all of the plurality of blocks and verifies validity of the whole collected blocks.

14. A method for upgrading a software program comprising the steps of;
receiving data of an upgraded soft program separated to a plurality of blocks;
testing validity of data existing in the a plurality of blocks;
collecting the blocks passed the validity test;
verifying validity of the whole collected blocks; and
installing the software program in a satellite-broadcasting receiver by receiving the above verified blocks.

15. The method of claim 14, wherein the data failed in the validity test is registered as a non-received state.

16. The method of claim 14, wherein the plurality of blocks are transmitted having a time difference of the block unit time for each broadcasting channel.

17. The method of claim 14, further comprising a step of:
testing validity of the data block by receiving data blocks which are not collected among the data blocks transmitted through a plurality of channels.

18. The method of claim 14, wherein the data blocks are stored in a memory of the receiver.

19. The method of claim 14, further comprising a step of:
registering the block as a non-received state in case data in the received plurality of blocks are damaged by external noise and not valid and repeating the validity test until the data blocks are all collected normally.

20. The method of claim 14, wherein the verified blocks are stored in a memory in the satellite broadcasting receiver.
